(19) United States
(12) Patent Application Publication
(10) Pub. No.: US 2021/0047017 A1
(43) Pub. Date: Feb. 18, 2021

(54) WATERCRAFT, SUCH AS A SURFBOARD OR A PADDLEBOARD, WITH CONTROLLED ELECTRICAL ASSISTANCE

(71) Applicant: MOTION CONCEPT GROUP, Libourne (FR)

(72) Inventor: Nicolas QUENDEZ, Chezy-en-Orxois (FR)

(73) Assignee: MOTION CONCEPT GROUP, Libourne (FR)

(21) Appl. No.: 16/990,932

(22) Filed: Aug. 11, 2020

(30) Foreign Application Priority Data
Aug. 12, 2019 (FR) 1909139

(51) Int. Cl. B63B 79/40; B63B 32/10

(52) U.S. Cl. CPC B63B 79/40; B63B 32/10

(57) ABSTRACT

The present invention relates to a watercraft with controlled electrical assistance, aiming at allowing the transportation of a user on water. It finds a particular application in the field of surfboards, paddleboards or sailboards, and in the field of kayaks or canoes.
The watercarft comprises propulsion means 1 capable of allowing the watercraft to progress on or in the water, one electrical motor configured to deliver power for driving the propulsion means 1, a source 3 of electrical energy configured to supply the motor with electrical energy, and an electronic control unit configured to control the operation of the motor and the supply of the motor with electrical energy by the source.
The watercraft further comprises measuring means 5, 6, 7 connected to the control unit 4 and capable of measuring the value of at least one given parameter among a motor parameter relating to motor operation, and a watercraft parameter relating to the movement of the watercraft, and the control unit 4 is configured to receive at least one value of the motor parameter and/or the watercraft parameter, measured by the measuring means 5, 6, 7, and to adapt the power for drinving the propulsion means 1 delivered by the motor, depending on the parameter value or values received.

### FIELD OF THE INVENTION

The present invention relates to a watercraft with controlled electrical assistance, aiming at allowing the transportation of a user on water. It finds a particular application in the field of surfboards, paddleboards or sailboards, and in the field of kayaks or canoes.

### BACKGROUND OF THE INVENTION

As an example, a surfboard is intended to allow a user to slip on the water under the action of propulsion provided by a wave. Generally, in the absence of a wave in a given area where the user is located, said user, lying on the board, uses his arms to provide the propulsion necessary for the board to reach an area where a wave is formed or is being formed.

Another example consists in a paddleboard which, in turn, is designed to allow a user to slide on the water under the action of propulsion of a user equipped with a paddle. As with a surfboard, the paddleboard can also allow the user to slide on the water under the action of propulsion provided by a wave.

Other examples exist of watercrafts which allow a user to navigate the water, by means of a mechanical action of propulsion which the user provides himself directly or by means such as one or more paddles or oars, and/or by means of an action of propulsion provided by the environment, such as wind or a wave.

To facilitate the use of such watercrafts, in particular to facilitate propulsion in areas where or at times when the mechanical action of propulsion provided by the user or by the environment is insufficient, these watercrafts can be equipped with electrical assistance, that is, an electrical motorization system that drives mechanical propulsion means such as a propeller.

For example, from US018065717 is known an inflatable paddle board with electrical assistance. In this document, a control electronics is provided, configured to detect that the paddle of the user is too far from the paddleboard and then to turn off the engine.

From US008262666 is also known a surfboard with electrical assistance, with remote control of the engine by means of a wrist strap worn by the user who communicates by wireless means with the control electronics, the latter being configured to detect a loss of signal from the wrist strap and then to shut down the engine.

Generally speaking, in known watercrafts with electrical assistance, engine control is carried out according to a device worn by the user. This therefore requires communication between the device in question and the control electronics which may cause reliability problems in certain conditions, and which is dependent on the user.

In addition, such control arrangements do not allow precise and optimized control of the power delivered by the electric motor to the mechanical means of propulsion

### SUMMARY OF THE INVENTION

The invention aims therefore at solving the problems mentioned, amongst other problems. One of the aims of the invention is therefore to offer a watercraft with electrical assistance with more efficient management of this electrical assistance.

The object of the invention is thus a watercraft, such as a surfboard or a paddleboard, with electrical assistance, comprising propulsion means capable of allowing the watercraft to progress on or in the water, one electrical motor configured to deliver power for driving the propulsion means, a source of electrical energy configured to supply the motor with electrical energy, and an electronic control unit configured to control the operation of the motor and the supply of the motor with electrical energy by the source.

The watercraft further comprises measuring means connected to the control unit and capable of measuring the value of at least one given parameter among a motor parameter relating to motor operation, and a watercraft parameter relating to the movement of the watercraft.

Besides, the control unit is configured to receive at least one value of the motor parameter and/or the watercraft parameter, measured by the measuring means, and to adapt the power for driving the propulsion means delivered by the motor, depending on the parameter value or values received.

In some embodiments, the watercraft further comprises one or more of the following features, considered alone or according to any technically possible combination:
the measuring means include means capable of measuring the electrical intensity consumed by the motor, and the control unit is configured to detect a change in the electrical intensity consumed by the motor, and to vary the electrical energy supplied to the motor according to the detected change in the electrical intensity consumed;
the control unit is configured to detect an increase, or decrease, in the electrical intensity consumed by the motor beyond a certain threshold for a specified duration, and to cut off the electrical energy supply to the motor in the event that the electrical intensity consumed by the motor exceeds, or falls below, the specified threshold, during the specified period;
the specified threshold is a function of at least the speed of rotation of the motor, and the specified duration is a function of at least the speed of rotation of the motor and/or at least the electrical intensity consumed by the motor;
the measuring means include means capable of measuring the speed of rotation the motor, and the control unit is configured to detect a change in the speed of rotation of the motor, and to vary the electrical energy supplied to the motor according to the detected change in speed;
the control unit is configured to detect an increase or decrease in the speed of rotation of the motor, beyond a certain threshold, for a specified duration, and to cut off the electrical energy supply to the motor in the event that the speed of rotation of the motor exceeds, or falls below, the specified threshold, during the specified period;
the specified threshold is a function of at least the electrical intensity consumed by the motor, and the specified duration is a function of at least the electrical intensity consumed by the motor and/or at least the speed of rotation of the motor;
the motor comprises electronic control means, and the means capable of measuring the electrical intensity consumed by the motor and/or the speed of rotation of the motor comprise an electronic measuring device integrated with the electronic means of control of the motor;
the measuring means comprise means, such as an inertial measurement unit, capable of detecting the speed and/or acceleration of the watercraft in translation along one or more of the three axes of displacement of the centre of gravity of the watercraft, and/or in rotation around one or more of the three axes of rotation of the centre of gravity of the watercraft, and the control unit is configured to detect a change in speed and/or acceleration of the watercraft, and to vary the electrical energy supply to the motor according to the change in speed and/or acceleration detected;
the measurement means comprise means capable of detecting an action of propulsion from a user present on the watercraft, such as a camera and/or an inertial measurement unit, and the control unit is configurated to detect a change in the frequency of action of propulsion from a user present on the watercraft, and to vary the electrical energy supply to the motor according to the change in frequency of action of propulsion detected.

So, the watercraft with electrical assistance of the invention allows to manage this electrical assistance in a precise and optimized manner, according to one or more parameters related to the motor and/or the watercraft.

### DRAWINGS

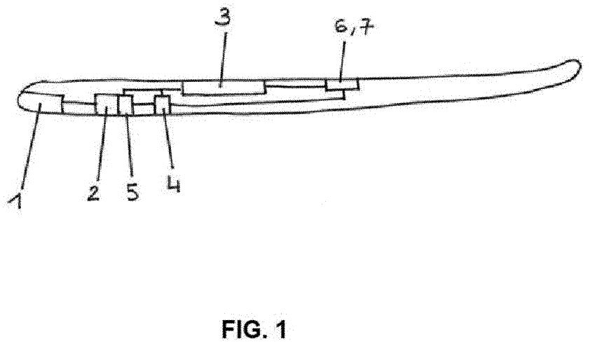

The invention and its advantages may be better understood by referring to the description which follows, given as example and for illustrative purpose only, and by referring to FIG. 1 which shows schematically an example of a watercraft according to the invention.

### DETAILED DESCRIPTION

FIG. 1 thus illustrates an example in which the watercraft is of the surfboard type. This board is equipped with electrical assistance that allows to assist the user in his displacements on the water, for example to reach more easily a surfing area.

The board comprises means of propulsion 1, such as a propeller carried by a drive axis, capable of allowing the board to progress on the water. In other examples where the watercraft is intended to be totally or partially submerged, the progress of the watercraft can be made in the water.

In addition, the board comprises an electrical motor 2 configured to deliver driving power to drive the propulsion means 1, linked for example to the drive axis of the propeller.

A source 3 of electrical energy, such as one or more electrical batteries, is also provided, configured to supply the motor 2 in electrical energy.

The operation of motor 2, and its supply in electrical energy from source 3, are controlled by an electronic control unit 4. This electronic control unit 4 comprises computing means, such as a microcontroller. It is connected to measuring means 5, 6, 7. These measuring means 5, 6, 7 are capable of measuring the value of one or more given parameters, on the basis of which the driving power delivered by the motor 2 is adapted.

Precisely, these means of measurement 5, 6, 7 measure the value of a motor parameter and/or a watercraft parameter. The motor parameter is a parameter relating to the operation of the motor. The watercraft parameter is a parameter relating to the movement of the watercraft.

The control unit 4 is configured to receive one or more values of the parameter or parameters in question, namely the motor parameter and/or the watercraft parameter, measured by measuring means 5, 6, 7.

Depending on this or these received values, the control unit 4 is further configured to adapt the driving power of the propulsion means 1 delivered by the motor 2.

The measuring means 5, 6, 7 comprise for example means 5 capable of measuring the electrical intensity consumed by the motor 2. They may also include means 5 capable of measuring the speed of rotation of the motor 2. These two means are referenced with the same numerical reference 5, because they are preferably integrated into electronic control means 5, integrated in the motor 2 itself, in the form of electronic measurement devices integrated into these electronic control means 5.

For example, the motor 2 can be equipped with an integrated sensor on or in this motor 2, such as a Hall effect sensor that detects the passage of the rotating magnets. This information is therefore available for the control unit 4, via the electronic control means 5 integrated into the motor 2.

In another example, the electronic means of control 5 integrated into the motor 2 directly measure the electromotive force generated by the windings of the motor 2, which is a function of the speed of rotation of the motor 2. Similarly, this information is therefore available for the control unit 4, via the electronic control means 5 integrated into the motor 2, or possibly directly measured by the control unit 4.

With regard to the electrical intensity consumed by the motor 2, the latter can be fitted with an electrical intensity sensor that provides the electronic means 5 of control integrated into the motor 2. The information is then also available for the control unit 4, via these electronic means of control 5.

The means of measurement 5, 6, 7 may also comprise means 6, such as an inertial measurement unit 6, capable of detecting the speed and/or acceleration of the watercraft in translation along one or more of the three axes of displacement of the centre of gravity of the watercraft, and/or in rotation around one or more of the three axes of rotation of the centre of gravity of the watercraft.

These means of measurement 5, 6, 7 may also comprise means 6, 7 capable of detecting an action of propulsion from a user present on the watercraft, such as a camera 7 and/or an inertial measurement unit 6. The inertial measurement unit 6 may be the same as the inertial measurement unit 6 used in the measuring means 6 capable of detecting the speed and/or acceleration of the watercraft as presented in the preceding paragraph, hence the use of the same numerical reference 6.

By the action of propulsion from a user present on the watercraft, it is meant the physical action of that user to move the watercraft in a particular direction. In the case of a surfboard, it may be arm movements in the water made by the user lying on on the board to move the board forward. In the case of a paddleboard, this can be the paddling movements made by the user by means of a paddle to move the paddleboard forward. In the case of a canoe or kayak, this may be the paddling movements made by the user to move the watercraft forward

The control unit 4 can therefore use the values measured by one or more of the different measuring means 5, 6, 7 for the control of the motor 2.

Thus, the control unit 4 is configured to detect a change in the electrical intensity consumed by the motor 2 from information received from means 5 capable of measuring the electrical intensity consumed by the motor 2 presented above. The control unit 4 is then configured to vary the supply of electrical energy to the motor 2, based on the detected change in the consumption of electrical intensity.

Specifically, the control unit 4 is configured to detect an exceedance of the electrical intensity consumed by motor 2 beyond a certain threshold, for a specified duration. This may be an increasing exceedance, in which case the threshold determined is a high threshold, or a decreasing exceedance, in which case the threshold determined is a low threshold.

The control unit 4 is then configured to cut or turn off the supply of electrical energy to the motor 2 in the event that the electrical intensity consumed by the motor 2 exceeds, of lass below, the specified threshold, during the specified duration.

In a particular embodiment, the determined threshold (high or low) used by the control unit 4, is a function of at least the rotation speed of the motor 2. The determined duration is a function of at least the rotation speed of the motor 2 and/or at least the electrical intensity consumed by the motor 2.

Thus, and by way of example, let us consider that the control unit 4 takes into account two distinct speeds of rotation of the motor 2, V1 and V2, with V2 greater than V1. If, while motor 2 is running at speed V1, the electrical intensity consumed by the motor 2 is less than 4 amperes during 1500 ms, the control unit 4 cuts off the motor 2, that is to say, cuts off the supply of electrical energy to it. If, while the motor 2 is running at speed V2, the electric intensity consumed by the motor 2 is less than 3 amperes for 1500 ms, the control unit 4 cuts off the motor 2, that is to say, cuts off the supply of electrical energy to it.

Indeed, if the electrical intensity consumed by the motor 2 decreases, while its speed increases, there may be two possible reasons.

Either the user has fallen off the board, and the board ends up on the surface of the water, with propulsion means 1, such as a propeller, partly out of the water. The propeller then brews a lot of air and not just water, which reduces the consumption of electrical energy by the motor 2, and accelerates the rotation of the propeller, therefore of the motor 2. This is detected by the control unit 4, as explained above, which allows it to vary the driving power delivered by the motor 2, up to the complete stop if necessary.

Either the user is on his board and surfs a wave. The propulsion means 1 are still submerged, but it is no longer necessarily those propulsion means 1 which provide propulsion for the board because the wave also drives it. In this case, the consumption of electrical energy of the motor 2 decreases, and the speed of the propeller increases (this can go as far as the propeller being driven in rotation due to the speed of displacement of the board). This is detected by the control unit 4, as explained above, allowing it to vary the driving power delivered by the motor 2, to result in the speed of rotation of the motor 2 decreasing to full stop or awaiting recovery of a certain load on the propeller to further increase the speed of rotation of the motor.

The control unit 4 can also be configured to detect a change in the rotation speed of the motor 2, based on information received from means 5 capable of measuring the rotation speed of the motor 2 presented above. The control unit 4 is then configured to vary the supply of electrical energy to the motor 2 according to the speed variation detected.

Furthermore, if the electrical intensity consumed by the motor 2 increases, this may be related to a technical problem, such as a blocking of the propeller, a winding of algae around it, etc. . . . . This is detected by the control unit 4, as explained above, allowing it to stop any propulsion urgently.

Specifically, the control unit 4 is configured to detect an exceedance of the rotation speed of the motor 2 beyond a certain threshold for a specified duration. Again, it may be an increasing exceedance, in which case the threshold determined is a high threshold, or a decreasing exceedance, in which case the threshold determined is a low threshold.

The control unit 4 is then configured to cut off the supply of electrical energy to the motor 2 in the event that the rotation speed of the motor 2 exceeds, increasing or decreasing, the determined threshold, during the specified duration.

In a particular embodiment, the determined threshold (high or low) used by the control unit 4, is a function of at least the electrical intensity consumed by the motor 2. The determined duration is a function of at least the electrical intensity consumed by the motor 2 and/or at least the speed of rotation of the motor 2.

The control unit 4 can also be configured to detect a change in the speed and/or acceleration of the watercraft, on the basis of information received from means 6 capable of detecting this speed and/or acceleration of the watercraft presented above. The control unit 4 is then configured to vary the supply of electrical energy to the motor 2 according to the detected speed and/or acceleration variation.

The control unit 4 can also be configured to detect a change in the frequency of action of propulsion from a user present on the watercraft, based on information received from means 6, 7 able to detect an action of propulsion from a user present on the watercraft presented above. The control unit 4 is then configured to vary the supply of electrical energy to the motor 2 according to the detected variation in the frequency of action of propulsion.

The above description is given as example and for illustrative purpose only.

In particular, and although the invention is of particular interest in application to the field of surfboards, it is not limited to a surfboard-type watercraft, but extends to watercrafts such as a paddleboard or a sailboard. More generally, the invention is not limited to a board-type watercraft, but extends to any electrically assisted craft, such as a canoe or kayak

1. A watercarft with electrical assistance, comprising propulsion means capable of allowing the watercraft to progress on or in the water, one electrical motor configured to deliver power for driving the propulsion means, a source of electrical energy configured to supply the motor with electrical energy, and an electronic control unit configured to control the operation of the motor and the supply of the motor with electrical energy by the source,
wherein it further comprises measuring means connected to the control unit and capable of measuring the value of at least one given parameter among an motor parameter relating to motor operation, and a watercraft parameter relating to the movement of the watercraft, and wherein the control unit is configured to receive at least one value of the motor parameter and/or the watercraft parameter, measured by the measuring means, and to adapt the power for driving the propulsion means delivered by the motor, depending on the parameter value or values received.

2. A watercraft according to claim 1, wherein the measuring means include means capable of measuring the electrical intensity consumed by the motor, and wherein the control unit is configured to detect a change in the electrical intensity consumed by the motor, and to vary the electrical energy supplied to the motor according to the detected change in the electrical intensity consumed.

3. A watercraft according to claim 2, wherein the control unit is configured to detect an increase, or decrease, in the electrical intensity consumed by the motor beyond a certain threshold for a specified duration, and to cut off the electrical energy supply to the motor in the event that the electrical intensity consumed by the motor exceeds, or falls below, the specified threshold, during the specified period.

4. A watercraft according to claim 3, wherein the specified threshold is a function of at least the speed of rotation of the motor, and the specified duration is a function of at least the speed of rotation of the motor and/or at least the electrical intensity consumed by the motor.

5. A watercraft according to claim 1, wherein the measuring means include means capable of measuring the speed of rotation of the motor, and wherein the control unit is configured to detect a change in the speed of rotation of the motor, and to vary the electrical energy supplied to the motor according to the detected change in speed.

6. A watercraft according to claim 5, wherein the control unit is configured to detect an increase or decrease in the speed of rotation of the motor, beyond a certain threshold, for a specified duration, and to cut off the electrical energy supply to the motor in the event that the speed of rotation of the motor exceeds, or falls below, the specified threshold, during the specified period.

7. A watercraft according to claim 6, wherein the specified threshold is a function of at least the electrical intensity consumed by the motor, and the specified duration is a function of at least the electrical intensity consumed by the motor and/or at least the speed of rotation of the motor.

8. A watercraft according to claim 2, wherein the motor comprises electronic control means, and wherein the means capable of measuring the electrical intensity consumed by the motor comprise an electronic measuring device integrated with the electronic means of control of the motor.

9. A watercraft according to claim 5, wherein the motor comprises electronic control means, and wherein the means capable of measuring the speed of rotation of the motor comprise an electronic measuring device integrated with the electronic means of control of the motor.

10. A watercraft according to claim 1, wherein the measuring means comprise means capable of detecting the speed and/or acceleration of the watercraft in translation along one or more of the three axes of displacement of the centre of gravity of the watercraft, and/or in rotation around one or more of the three axes of rotation of the centre of gravity of the watercraft, and wherein the control unit is configured to detect a change in speed and/or acceleration of the watercraft, and to vary the electrical energy supply to the motor according to the change in speed and/or acceleration detected.

11. A watercraft according to claim 10, wherein the means capable of detecting the speed and/or acceleration of the watercraft in translation along one or more of the three axes of displacement of the centre of gravity of the watercraft, and/or in rotation around one or more of the three axes of rotation of the centre of gravity of the watercraft, is an inertial measurement unit

12. A watercraft according to claim 1, wherein said watercraft is a surfboard.

13. A watercraft according to claim 1, wherein said watercraft is a paddleboard.
